(19) United States
(12) Patent Application Publication
(10) Pub. No.: US 2011/0060852 A1
(43) Pub. Date: Mar. 10, 2011

(54) COMPUTER SYSTEM AND DATA TRANSFER METHOD THEREIN

(75) Inventors: Hideaki Komatsu, Kanagawa-ken (JP); Fumitomo Ohsawa, Kanagawa-ken (JP); Nobuaki Takahashi, Kanagawa-ken (JP); Gang Zhang, Kanagawa-ken (JP)

(73) Assignee: INTERNATIONAL BUSINESS MACHINES CORPORATION, Armonk, NY (US)

(21) Appl. No.: 12/874,283

(22) Filed: Sep. 2, 2010

(30) Foreign Application Priority Data
Sep. 4, 2009 (JP) 2009-205077

(51) Int. Cl. G06F 13/28

(52) U.S. Cl. 710/22

(57) ABSTRACT

A DMA transfer technique which can be adapted to “hardware in the loop simulation” (HILS) and which requires less overhead. In a computer system having a data transfer device, a continuous DMA mechanism successively and repeatedly outputs a data transfer request in response to an enable process. A simulation system for HILS places data as a result of the simulation in a predetermined area in a memory and transfers the data from the memory to the continuous DMA mechanism together with generation ID data. The continuous DMA mechanism stores the transferred generation ID as a received ID, and receives the transferred data in response to the event that the transferred generation ID differs from the received ID being stored. The continuous DMA mechanism successively repeats the data transfer request until it is disabled.

### CROSS REFERENCE TO RELATED APPLICATION

This application claims priority under 35 U.S.C. §119 from Japanese Patent Application No. 2009205077 filed Sep. 4, 2009, the entire contents of which are incorporated herein by reference.

### BACKGROUND OF THE INVENTION

1. Field of the Invention

The present invention relates to a system and method for transferring data between a memory in a computer and peripheral devices using a direct memory access (DMA) technique, and more particularly to a system and method for exchanging data between a memory in a computer and devices to be tested, such as an Electronic Control Unit (ECU), in a simulation system for “hardware in the loop simulation” (HILS) or the like.

2. Description of the Related Art

Recently, embedded systems which directly control hardware by microcomputers are increasingly commonly used in mobile phones, digital cameras, elevators, automobile ECUs, engine simulators, industrial robots, and others.

As in a general computer program, particularly in an embedded system, it is necessary to test a generated program under various conditions to determine that the program works properly.

One of the techniques conventionally used for such tests is “hardware in the loop simulation” (HILS). Particularly, the environment for testing an electronic control unit for an entire automobile is called “full-vehicle HILS”. In the full-vehicle HILS, a test is conducted in an experimental laboratory in accordance with a predetermined scenario by connecting an actual ECU to a personal computer or a dedicated hardware device for the purposes of software simulation of operations of an engine, transmission mechanism, and others. The output from the ECU is input into a monitoring computer, and also displayed on a display together with the operations of the engine, transmission mechanism, and others, so as to allow a person in charge of the test to check for abnormal operations while looking at the display.

In the HILS, the computer or the dedicated hardware device is physically connected to the actual ECU, and a direct memory access (DMA) technique is generally used for data transfer between the personal computer or the dedicated hardware device and the ECU.

The DMA-based data transfer is generally performed under the control of a DMA mechanism such as a DMA controller. The DMA mechanism includes an address register, a data size register, and a control register. To start the DMA-based data transfer, a starting address of a memory serving as a transfer source is set in the address register, the data size of the data to be transferred is set in the data size register, and lastly a command is written into the control register, which is followed by initiation of the data transfer.

FIG. 1 is a timing chart of a process of transferring data to an ECU in a conventional HILS. As shown in the figure, simulation software which is running on the computer or the dedicated hardware device issues a DMA transfer command to an interface board which has the DMA mechanism. In a typical conventional configuration, the issuance of the DMA transfer command (i.e. the DMA request) takes 6 μs. The data to be transferred consists of seven words, for example, in which case the data transfer completes in 600 ns. Thereafter, the interface board sends an interrupt to the simulation software for notification of the end of the transfer. This interrupt typically takes 4 μs.

In the simulation for testing the operations of the ECU by the HILS, as shown in FIG. 1, data of a relatively small size is transferred from the simulation software to the interface board and from the interface board to the simulation software. Such data transfer is performed periodically.

With the conventional configuration, transfer of each of such small-sized data pieces is always accompanied by overhead including the DMA request in the beginning and the interrupt at the end, hindering improvement of the transfer rate.

Japanese Unexamined Patent Publications Nos. 2000-20455, 2000-148663, and 2002-132706 each disclose that, in successively performing DMA transfer using different areas in a main memory as transfer destinations (or transfer sources), a DMA controller calculates a memory address of the transfer destination (or source) for each DMA transfer and sets the same in the address register to continuously perform the DMA transfer, so as to reduce the overhead for setting.

Japanese Unexamined Patent Publication No. 2007-79715 discloses a technique in which once DMA transfer is performed, the settings for the first DMA transfer are referred to in the subsequent DMA transfer for continuously performing DMA transfer.

The above publications each discuss the technique of performing DMA transfer continuously by reducing the overhead required for the DMA transfer. With the methods disclosed therein, however, the simulation software may not be able to conduct updating of data on a memory and DMA transfer of the updated data properly and in a synchronized manner.

### SUMMARY OF THE INVENTION

According to an aspect of the present invention, a computer system having a data transfer device for transferring data from a memory in a computer to a peripheral device via Direct Memory Access (DMA) is presented. The computer system includes:
a continuous DMA mechanism configured to successively and repeatedly output a data transfer request in response to an enable process;
means for placing, in the memory, data to be transferred to the continuous DMA mechanism and generation ID data, the generation ID data being updated whenever the data is placed in the memory;
means for transferring the data together with the generation ID data from the memory to the continuous DMA mechanism in response to a data read and transfer request from the continuous DMA mechanism; and
means for disabling the continuous DMA mechanism,
wherein continuous DMA mechanism comprises:
   means for storing the transferred generation ID as a received ID; and
   means for receiving the transferred data in response to the event that the transferred generation ID differs from the received ID being stored.

According to another aspect of the present invention, a data transfer method in a computer system having a data transfer device for transferring data from a memory in a computer to a peripheral device is presented. The data transfer method includes the steps of:
successively and repeatedly outputting a data transfer request by a continuous DMA mechanism in response to an enable process;
placing, in the memory, data to be transferred to the continuous DMA mechanism and generation ID data, the generation ID data being updated whenever the data is placed in the memory;
transferring the data together with the generation ID data from the memory to the continuous DMA mechanism in response to a data read and transfer request from the continuous DMA mechanism;
storing, by the continuous DMA mechanism, the transferred generation ID as a received ID;
receiving the transferred data in response to the event that the transferred generation ID differs from the received ID being stored; and
disabling the continuous DMA mechanism.

According to the present invention, it is possible to improve the overall processing speed by decreasing the overhead for the DMA requests by the use of the continuous DMA technique and by transmitting and receiving only the updated data by the use of the generation ID.

### BRIEF DESCRIPTION OF THE DRAWINGS

FIG. 1 is a timing chart of a conventional DMA transfer process between a computer and an ECU in the HILS.

FIG. 2 is a block diagram of the hardware for implementing the present invention.

FIG. 3 is a block diagram showing the configuration of an interface board.

FIG. 4 is a configuration diagram showing how actual ECUs are connected.

FIG. 5 is a configuration diagram showing how the ECUs are connected in groups.

FIG. 6 is a process flowchart illustrating the continuous DMA operations.

FIG. 7 shows a receive buffer, a send buffer, and a previously-received-generation-ID storage area which are secured on a main storage by simulation software.

FIG. 8 is a flowchart illustrating the operations of the simulation software.

FIG. 9 is a flowchart illustrating the process of reading data from a memory, which is performed by a DMA controller.

FIG. 10 is a flowchart illustrating the process of writing data into the memory, which is performed by the DMA controller.

FIG. 11 is a flowchart illustrating the process of reading data from the memory, performed by the DMA controller, with a learned delay of access timing.

FIG. 12 is a timing chart illustrating the effects obtained by the learned delay of the access timing.

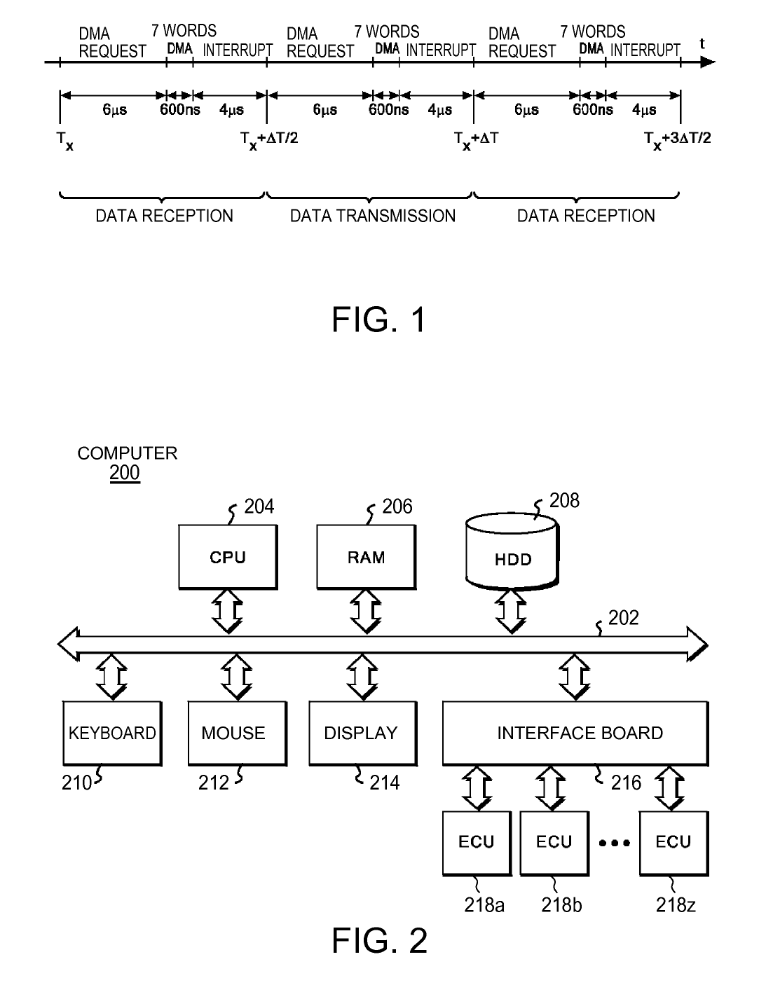

### DETAILED DESCRIPTION OF THE PREFERRED EMBODIMENTS

The present invention uses the concept of continuous DMA. Specifically, in the present invention, once the DMA transfer is enabled, an interface board repeatedly requests the data transfer until the DMA transfer is disabled. This can reduce the overhead for the DMA requests.

In the HILS, software simulation results of the operations of an engine, transmission mechanism, and others are supplied to an input of the ECU, and an output of the ECU is input into the simulation system. When continuous DMA is used to transfer data between the simulation system and the ECU, the simulation output stored in the memory, before being updated, may erroneously be supplied to the ECU by the DMA transfer, ahead of completion of the software simulation. Moreover, before the ECU operates and updates the output, the output may erroneously be input into the simulation system. In order to solve these problems, according to the present invention, the simulation system adds a generation ID to the output data, and updates the generation ID whenever the output data is updated. The interface board is configured to transfer only the data having an updated generation ID to the ECU.

Such a configuration using generation IDs is also used when the interface board transmits the data received from the ECU to the simulation system.

When the continuous DMA technique is used, data transfer is performed repeatedly, resulting in an increased number of accesses to the main memory via the system bus. This imposes a large burden on the HILS system, causing a delay in response of the HILS system. In order to solve these problems, according to the present invention, the interface board is configured to learn the data updating timing, so as to transfer the data at the learned timing. This can avoid unnecessary data accesses.

Hereinafter, embodiments of the present invention will be described with reference to the drawings. Throughout the drawings, the similar reference characters denote the similar objects, unless otherwise specified. It should be noted that the embodiments described below are only illustrative; they are not to restrict the invention to what is described therein.

Referring to FIG. 2 showing a block diagram of a computer 200 for implementing the system configuration and processing according to an embodiment of the present invention, preferably, a CPU 204, a main storage (RAM) 206, a hard disk drive (HDD) 208, a keyboard 210, a mouse 212, and a display 214 are connected to a system bus 202. The CPU 204 is preferably based on a 32-bit or 64-bit architecture. For example, Intel Pentium™ 4, Core™ 2 Duo, Xeon™, AMD Athlon™, and the like may be used. The main storage 206 preferably has a capacity of 2 GB or more.

An interface board 216 is also connected to the bus 202. The interface board 216, which will be described later in detail, is mounted with a logical circuit which implements the DMA mechanism according to the present invention.

A plurality of electronic control units (ECUs) 218a, 218b, through 218z are also connected to the interface board 216 via predetermined interface logic. In this example, the ECUs to be tested are those for an automobile.

Each of the ECUs such as 218a, 218b through 218z is a small computer in itself, which in an actual machine operates in accordance with an interrupt from a sensor input or the like. On the other hand, the engine and others continuously perform mechanical operations. That is, the computer-based digital system and the machine-based physical system co-operate in parallel in a single system as an automobile. In the present embodiment, the ECUs 218a, 218b, through 218z are configured to issue signals for driving an engine injector, transmission gearshift control, brake valve control, door locks, and others. In the following, the ECUs 218a, 218b, through 218z may collectively be referred to as the ECU 218 for convenience's sake.

The hard disk drive 208 stores in advance an operating system (not shown). The operating system may be any of Linux™, Microsoft Windows XP™, Windows™ 2000, Apple Computer Mac OS™, and other operating systems that can be adapted to the CPU 204.

The hard disk drive 208 also stores simulation software according to the present invention. The simulation software is loaded to the main storage 206 by the operating system, to generate data so as to drive each of ECUs 218a, 218b, through 218z via the interface board 216 under a scenario according to the operations of the actual vehicle.

The keyboard 210 and the mouse 212 are used for starting the operating system or a program (not shown) that is loaded from the hard disk drive 208 to the main storage 206 and displayed on the display 214, and for inputting characters.

The display 214 is preferably a liquid crystal display, which may have an arbitrary resolution such as, XGA (1024×768) or UXGA (1600×1200).

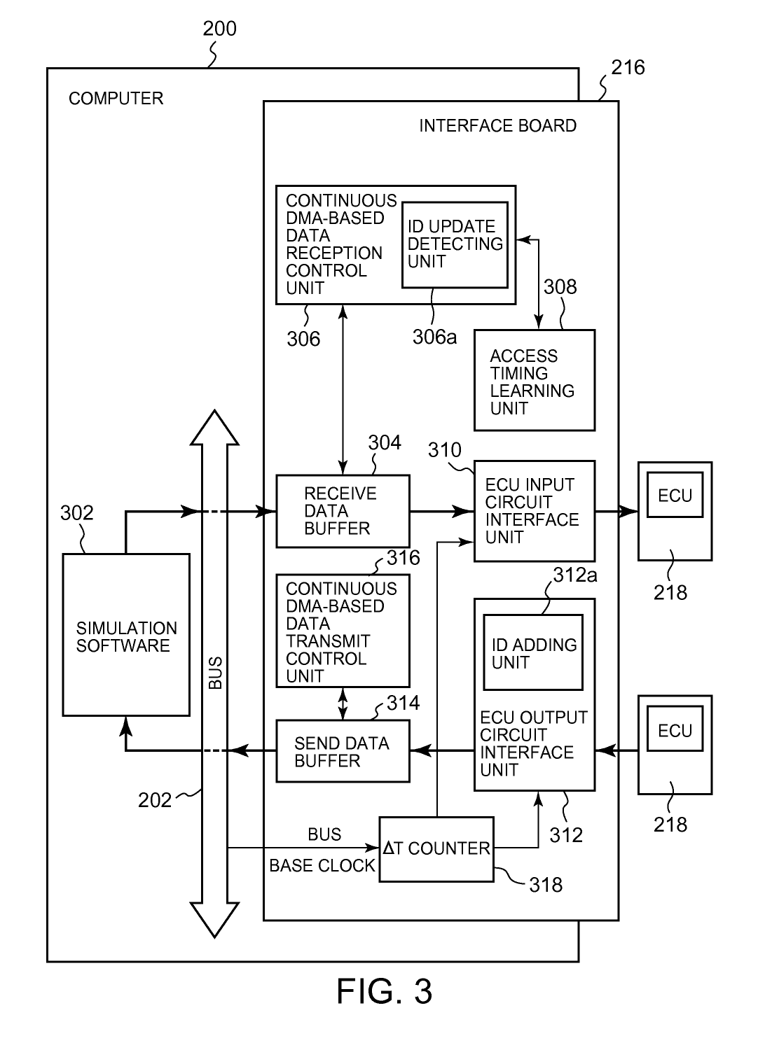

FIG. 3 is a block diagram primarily showing a more detailed configuration of the interface board 216.

Referring to FIG. 3, the simulation software 302 is stored in the hard disk drive 208 of the computer 200, as described above. At the start of the computer 200, it is loaded to the main storage 206 by the operating system for execution. The simulation software 302 has a function of enabling or disabling the DMA-based data transfer function provided in the interface board 216. Further, the simulation software 302 simulates operations in the automobile plant in units of ΔT time (ΔT refers to the simulation time interval, which may be set by an operator who is in charge of the test). As will be described later in detail, the simulation software 302 acquires from a predetermined area in the main storage 206 an output from the ECU 218 that has been transferred thereto, and uses the acquired output as its own input to perform a plant simulation for the ΔT time. Furthermore, the simulation software 302 loads the simulation output for the ΔT time to a predetermined area in the main storage 206, so as to be input into the ECU 218. The above operation is repeated until an end of execution of the HILS.

The simulation software 302 further has a function of adding a generation ID to the data to be transmitted to the ECU 218 and updating the same in a predetermined area in the main storage 206. The generation ID is updated by the simulation software 203 in response to the event that the data to be transmitted has all been updated.

In the interface board 216, a receive data buffer 304 has a function of receiving and temporarily storing the data which has been transferred from the simulation software 302 via the bus 202.

A continuous DMA-based data reception control unit 306 includes an ID update detecting unit 306a, which in turn has a received-ID register. The continuous DMA-based data reception control unit 306 has a function of receiving data and its generation ID which are updated by the simulation software 302 to a predetermined area in the main storage 206 for transmission to the ECU 218. Although not shown in the figure, the continuous DMA-based data reception control unit 306 has an address register for use in setting a starting address for reading from the main storage, and a data size register for use in setting the size of the data to be transferred. The continuous DMA-based data reception control unit 306 is configured such that, as the receive data buffer 304 is about to receive data having a generation ID from a predetermined area in the main storage 206, the unit 306 compares the generation ID of that data with the generation ID of data which has been received previously, and controls the receive data buffer 304 to receive the data only in the case where the generation ID of that data has been updated from that of the previously received data.

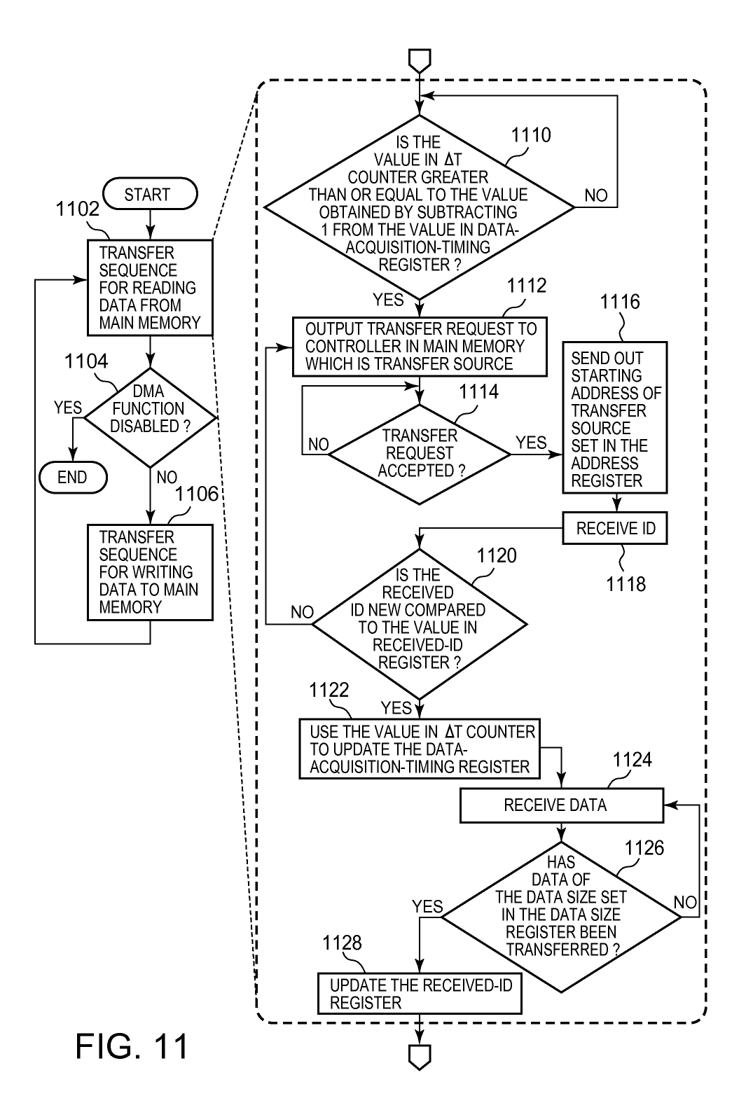

An access timing learning unit 308 has a data-acquisition-timing register, and learns the timing accessible to the updated data in accordance with the actual data access history, and stores the learned timing in the data-acquisition-timing register, to thereby reduce the number of times of accesses to the bus. The operation of the access timing learning unit 308 will be described later in detail with reference to FIG. 11.

The data received by the receive data buffer 304 is transmitted to an ECU input circuit interface unit 310, and then to the ECU 218.

The data may be received from the ECU 218 as well. An ECU output circuit interface unit 312 has an ID adding unit 312a, which in turn has a send-ID register. On receipt of data from the ECU 218, the ECU output circuit interface unit 312 updates the ID by the ID adding unit 312a. A send data buffer 314 receives from the ECU output circuit interface unit 312 the data to be transferred and the updated ID, and transfers them to a predetermined area in the main storage 206. The ECU output circuit interface unit 312 also stores in the send-ID register the ID at the time when data was transmitted to the send data buffer 314 previously.

A continuous DMA-based data transmit control unit 316 includes an address register (not shown) for use in setting a starting address for writing to the main memory, and a data size register (not shown) for use in setting the size of the data to be transferred.

The send data buffer 314 operates under the control of the continuous DMA-based data transmit control unit 316, to transfer to a predetermined area in the main storage 206 the data and its ID to be provided to the input of the simulation software 302. The simulation software 302, which stores the ID of the data that was received from the ECU 218 and used as an input for the previous simulation, compares the stored ID with the ID of the data present in the predetermined area in the main storage 206, and controls not to start the plant simulation in the case where the ID of the data present in the predetermined area in the main storage 206 has not been updated. In contrast, in the case where the ID of the data present in the predetermined area in the main storage 206 has been updated, the simulation software 302 updates the stored data ID, and uses the output of the ECU 218 that is present in the predetermined area in the main storage 206 as an input for the simulation, so as to simulate the operations of the automobile plant for the ΔT time.

A ΔT counter 318 takes in a clock from the computer 200 to generate a signal having a period of ΔT, and supplies the signal to the ECU input circuit interface unit 310 and the ECU output circuit interface unit 312. The ECU input circuit interface unit 310 and the ECU output circuit interface unit 312 operate on the basis of the signal having the period of ΔT, to control the timing for sending out data to the ECU 218 and the timing for taking in data from the ECU 218, respectively. More specifically, the ΔT counter 318 counts time on the basis of the bus clock, and supplies an input to the ECU 218 at the simulation time intervals ΔT and samples the output, to thereby carry out the simulation.

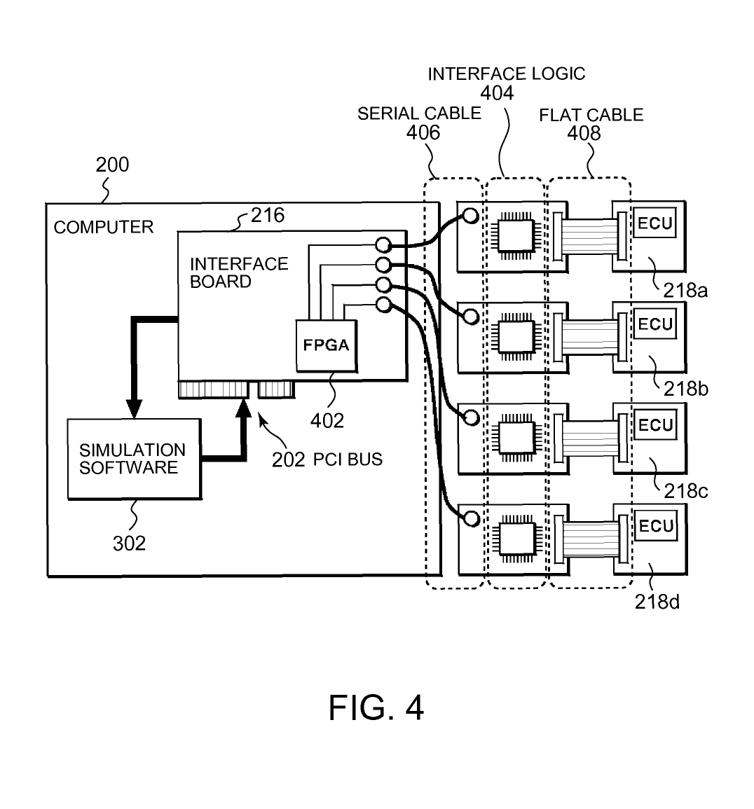

FIG. 4 is a configuration diagram showing connection of actual ECUs. As shown in FIG. 4, the interface board 216 may also be implemented with an FPGA (i.e. an integrated circuit which allows a user to define and modify an internal logical circuit) 402.

Referring to FIG. 4, interface logic 404 for example has the functions of both the ECU input circuit interface unit 310 and the ECU output circuit interface unit 312 shown in FIG. 3.

The interface logic 404 and the interface board 216 are preferably connected via a serial cable 406 such as an SMA cable.

On the other hand, the interface logic 404 and the ECU 218 are preferably connected via a parallel cable 408 such as a flat cable.

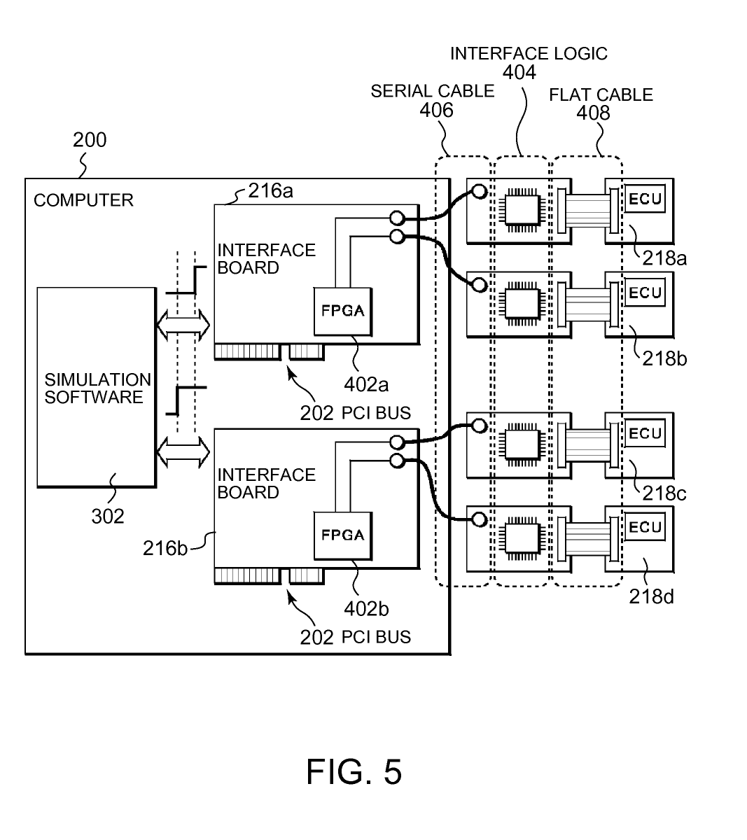

While FIG. 4 shows the configuration in which a single interface board 216 is used, FIG. 5 shows a configuration in which a plurality of interface boards 216a and 216b are used. When the simulation software 302 simulates a plurality of physical quantities including the engine injector, transmission gearshift control, and the like, the times required for calculating the physical quantities vary, and the timings when the simulation software 302 updates their output values vary as well. Thus, those having the updating timings relatively close to each other may be grouped advantageously so that the physical quantities in the same group are transferred to the ECU 218 at the same time using the same interface board. The plurality of interface boards 216a and 216b are used for such purposes.

In FIG. 5, the FPGAs 402a and 402b, the interface logic 404, the serial cable 406, and the flat cable 408 are identical to those in FIG. 4, and thus, description thereof will not be repeated.

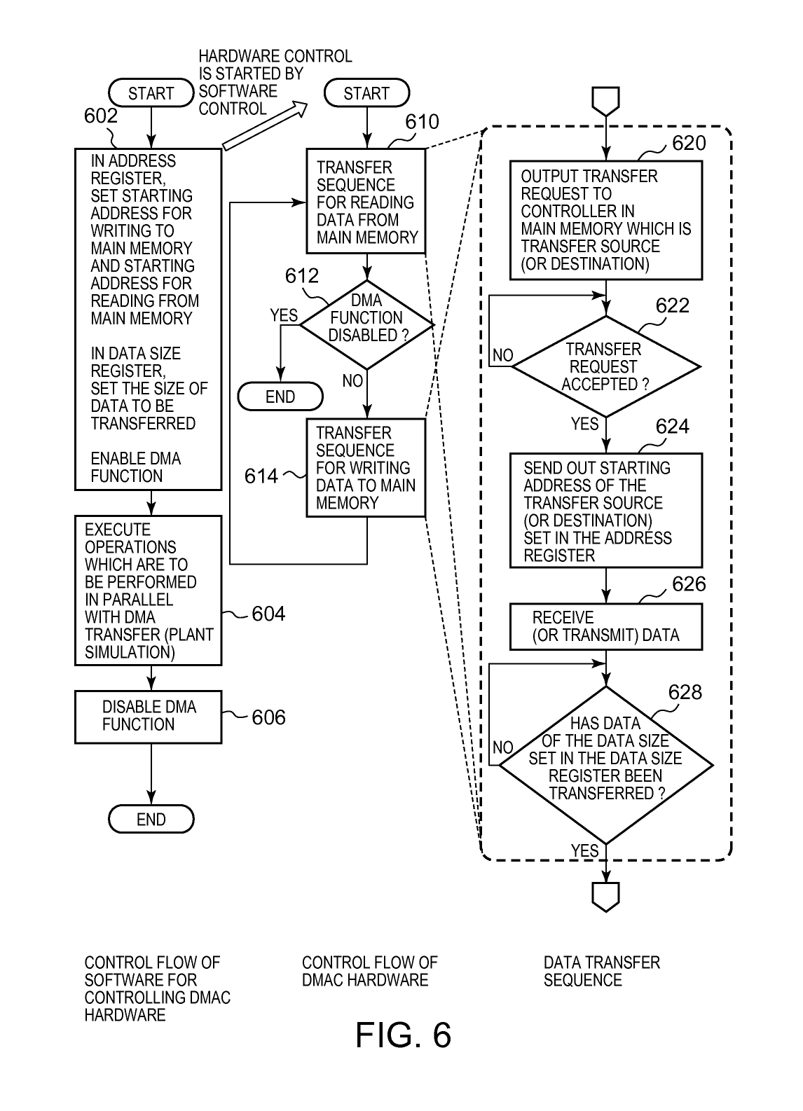

Hereinafter, a data transfer process using a DMA controller (DMAC) in the interface board 216 will be described with reference to a flowchart in FIG. 6. The process is divided into a process by software for controlling the DMAC and a process by hardware of the DMA controller. Here, the DMA controller refers to the entire transfer controlling mechanism on the interface board 216.

Referring to FIG. 6, the flowchart of steps 602, 604, and 606 shows the process flow of software for controlling the DMA controller, which is executed on the CPU 204. This corresponds to the process flow of the simulation software. In step 602, a starting address for writing to the main memory, i.e. the main storage, and a starting address for reading therefrom are set in the address register in the DMA controller. The size of the data to be transferred is set in the data size register. The DMA function is then enabled.

In step 604, the simulation software 302 executes operations including plant simulation, in parallel with the DMA transfer.

In step 606, the DMA function is disabled. The software operates in the above-described manner to control the DMA controller. In steps 602 and 606, operations on the DMA controller are carried out. The hardware of the DMA controller is enabled in step 602, and continues to operate until it is disabled in step 606. The process performed by the hardware of the DMA controller after it is enabled in step 602 will now be described in detail.

First, in step 610, a transfer sequence for reading data from the main memory is executed.

In step 612, it is determined whether the DMA function has been disabled. If it has not been disabled, the process proceeds to step 614. If it has been disabled, the DMA operation is terminated.

In step 614, a transfer sequence for writing data to the main memory is executed.

Steps 610 and 614 will now be described in more detail. First, in step 620, a transfer request is issued to a controller of the main memory, which is a transfer source in the case of step 610 and is a transfer destination in the case of step 614.

In step 622, it is determined whether the transfer request has been accepted. The process waits in step 622 until the transfer request is accepted.

When the transfer request is accepted, in step 624, the starting address of the transfer source that has been set in the address register is sent out in the case of step 610. In the case of step 614, the starting address of the transfer destination set in the address register is sent out.

In step 626, the data is received in the case of step 610, while the data is transmitted in the case of step 614.

In step 628, it is determined whether the data of the data size that has been set in the data size register has been transferred. If not, the process returns to step 626.

When the data of the data size set in the data size register has been transferred, the data transfer sequence is terminated, and the process proceeds to step 612.

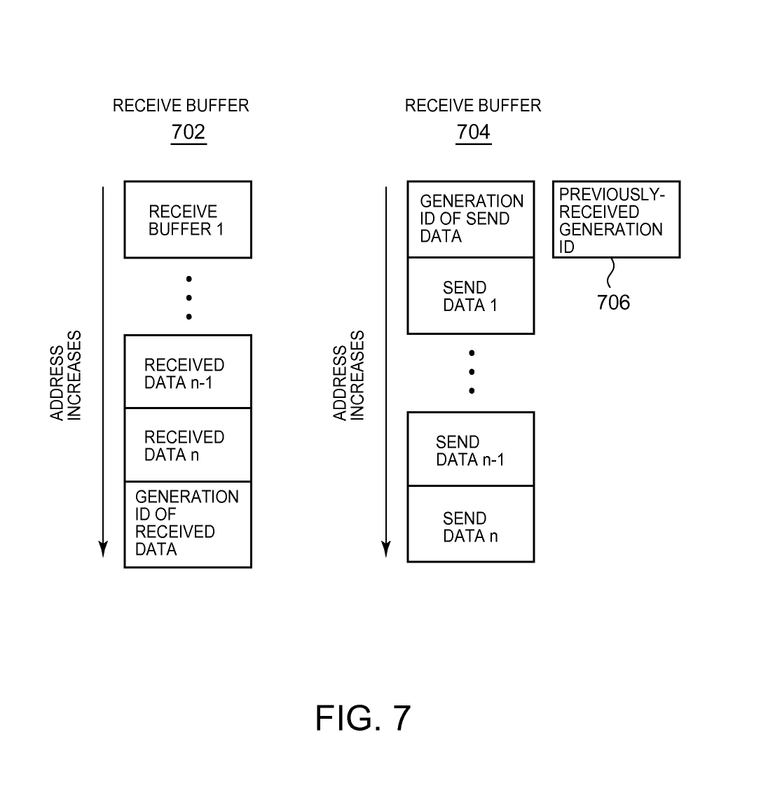

FIG. 7 shows the receive buffer 702, the send buffer 704, and the previously-received-generation-ID storing area 706, which are secured on the main storage 206 by the simulation software 302.

As shown in the figure, the receive buffer 702 and the send buffer 704 each occupy consecutive addresses in the main storage 206.

In the case of the send buffer 704, the generation ID of the send data is placed in the starting address, which is followed by the send data.

In the case of the receive buffer 702, the generation ID of the received data is placed in the last address, and the received data are placed in the addresses preceding that for the generation ID.

Although not shown in FIG. 7, the simulation software 302 further includes a function of storing and updating the generation ID of the send data. The generation ID may be updated in an arbitrary manner, for example by simply incrementing the value by 1 or by adding an appropriate value thereto. The manner of updating this generation ID may be applied to other generation IDs as well.

The previously-received-generation-ID storing area 706 is secured at a position on the main storage 206 that is completely different from the receive buffer 702 and the send buffer 705.

In the interface board 216, the receive data buffer 304 receives data from the send buffer 704, while the send data buffer 314 transfers data to the receive buffer 702. The previously-received-generation-ID storing area 706 updates the generation ID in response to the updating of the generation ID that is placed in the last address of the receive buffer 702.

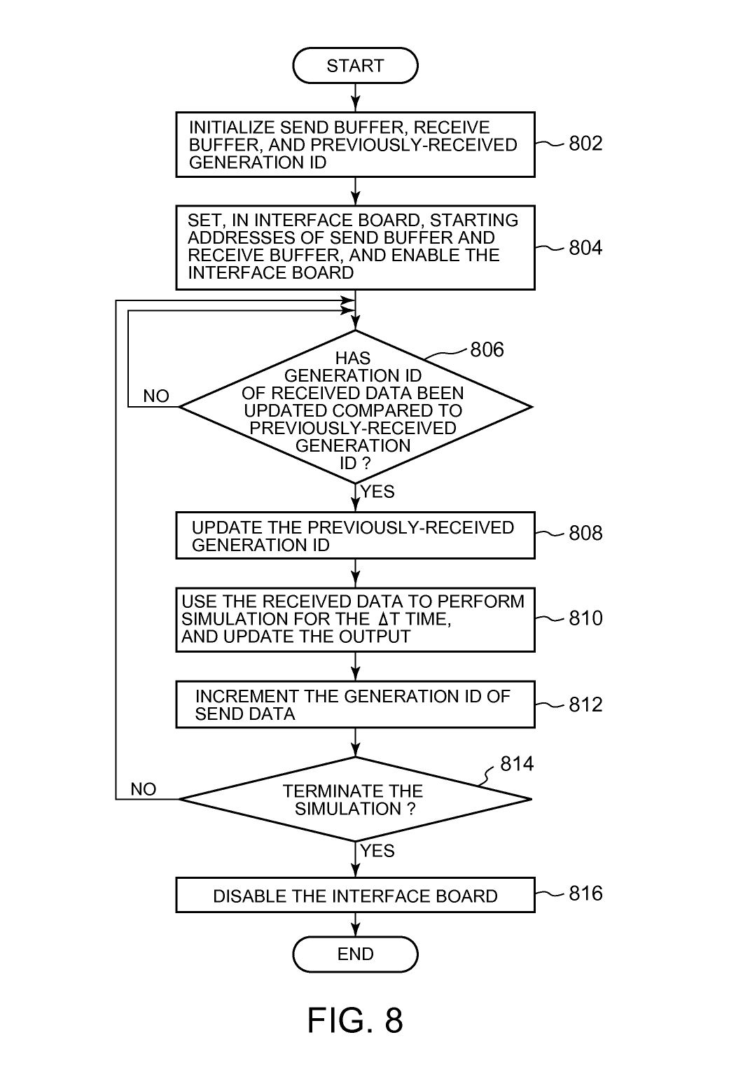

FIG. 8 is a flowchart illustrating, in more detail, the simulation operation by the simulation software 302 illustrated in FIG. 6. In step 802, the simulation software 302 initializes the send buffer 704, the receive buffer 702, and the previously-received-generation-ID storing area 706.

In step 804, the simulation software 302 sets the starting addresses of the send buffer 704 and the receive buffer 702 to the interface board 216, and then enables the interface board 216.

In step 806, the simulation software 302 compares the generation ID of the received data with the generation ID received previously, to determine whether the ID has been updated. If so, in step 808, the simulation software 302 updates the previously-received generation ID. Otherwise, the simulation software 302 waits in step 806.

Following the step 808, in step 810, the simulation software 302 uses the received data on the receive buffer 702 to perform simulation for the ΔT time, and updates the output data on the send buffer 704. The interface board 216, in accordance with a process which will be described later, issues a transfer request for data reading directed to the memory controller (not shown) in the computer 200, and in response to the event that the request is accepted, takes the content of the send buffer 704 into the receive data buffer 304 under the control of the continuous DMA-based data reception control unit 306.

The data taken into the receive data buffer 304 is transferred via the ECU input circuit interface unit 310 to the ECU 218 at an appropriate timing that is controlled by the ΔT counter 318.

The ECU 218 operates on the basis of the transferred data, and transfers the processing result of the operation to the ECU output circuit interface unit 312 at an appropriate timing controlled by the ΔT counter 318. The transferred data is stored in the send data buffer 314, together with the generation ID that has been updated by ID adding unit 312a.

Then, the interface board 216 outputs to the memory controller (not shown) in the computer 200 a transfer request for data writing, and in response to the event that the request has been accepted, writes the content of the send data buffer 314 to the receive buffer 702 under the control of the continuous DMA-based data transmit control unit 316. At this time, on the simulation software 302 side, the value of the generation ID on the receive buffer 702 that has been received from the interface board 216 may be compared with the value in the previously-received-generation-ID storing area 706. If the value of the generation ID on the receive buffer 702 has not been updated, the simulation software 302 may determine that the received data is the one that has already been processed, and refrain from using the data as an input for the simulation process.

In step 812, the simulation software 302 increments the generation ID of the send data.

In step 814, the simulation software 302 determines whether to terminate the simulation. The determination is made on the basis of the schedule of the simulation, or on the basis of the operation of the test operator who is in charge of the simulation.

If it is determined to continue the simulation, the process returns to step 806. If it is determined to terminate the simulation, the process proceeds to step 816, where the simulation software 302 disables the interface board 216.

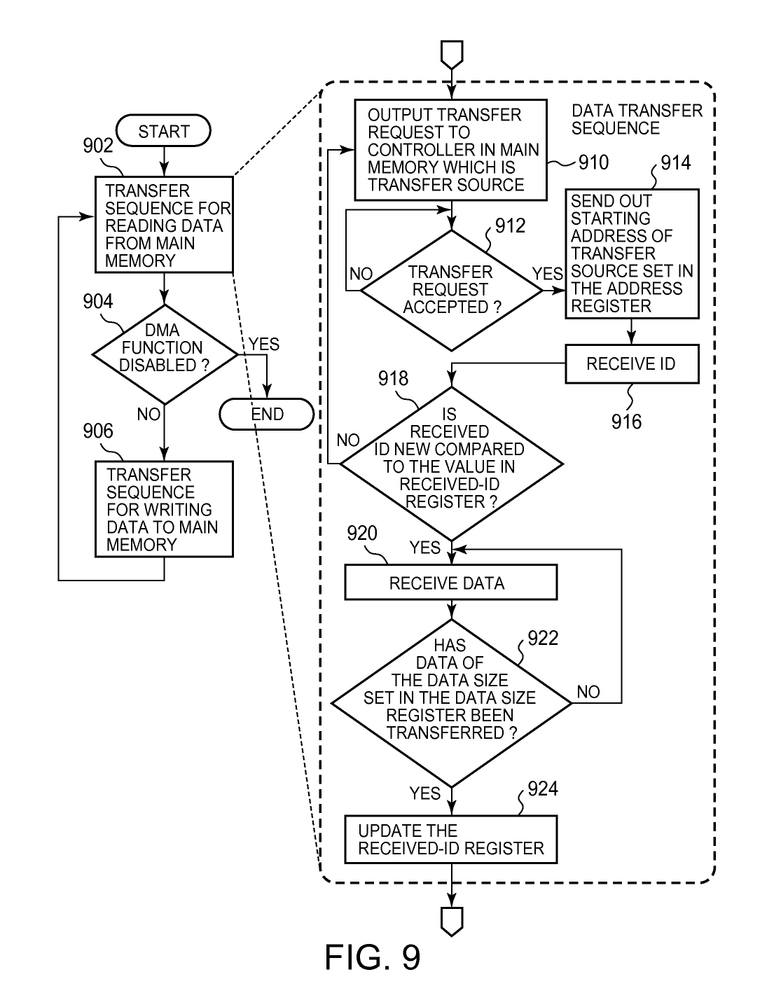

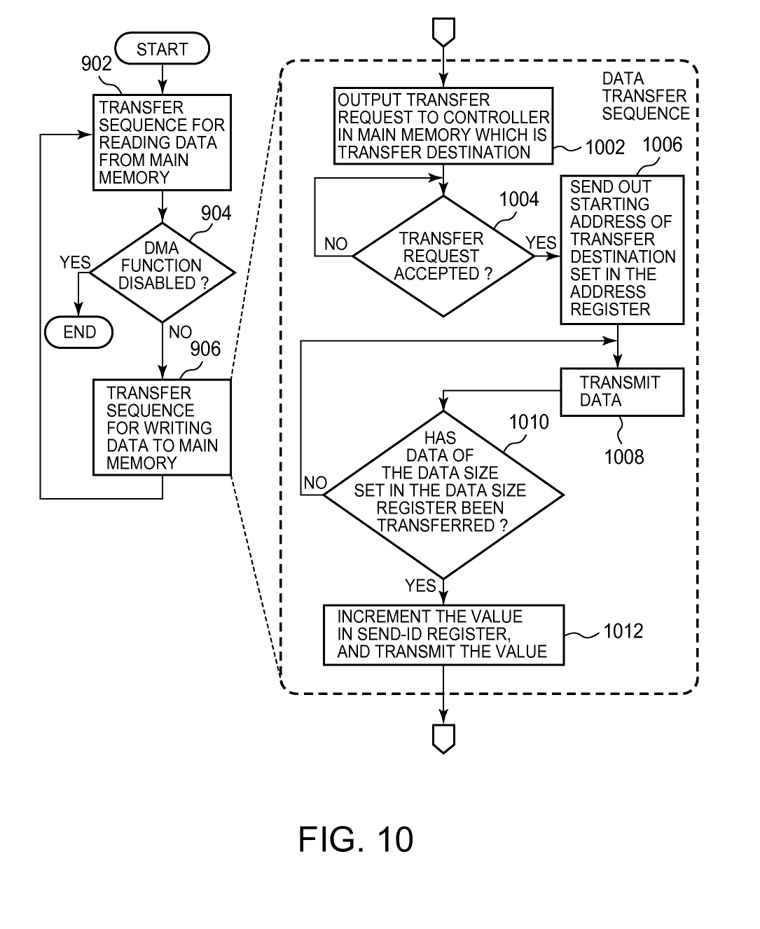

Now, the process of control of the DMAC hardware will be described with reference to the flowcharts in FIGS. 9 and 10. While the DMAC hardware control has been described in conjunction with FIG. 6, the more detailed process using the generation ID will be described below.

Referring to FIG. 9, firstly, a transfer sequence for reading data from the main memory is executed in step 902.

In step 904, it is determined whether the DMA function has been disabled. If it has not been disabled, the process proceeds to step 906; otherwise, the DMA operation is terminated.

In step 906, a transfer sequence for writing data to the main memory is executed.

The step 902 will now be described in more detail. First, in step 910, a transfer request is issued to the controller of the main memory which is a transfer source.

In step 912, it is determined whether the transfer request has been accepted. If not, the process waits in step 912.

When the transfer request is accepted, in step 914, the starting address of the transfer source that has been set in the address register is sent out.

In the following step 916, the data is received sequentially from the leading position of the send buffer 704 included in the main storage. Specifically, the ID is firstly received from the simulation software 302.

In step 918, it is determined whether the received ID is new compared to the value in the received-ID register. The received-ID register, provided in the continuous DMA-based data reception control unit 306, is a register for storing the received ID.

If the received ID is not new compared to the value in the received-ID register, the process returns to step 910.

If it is determined that the received ID is new compared to the value in the received-ID register, the data is received in step 920.

In step 922, it is determined whether data of the data size which has been set in the data size register has been transferred. If not, the process returns to step 920.

When the data of the data size set in the data size register has been transferred, in step 924, the value in the received-ID register is updated with the value of the received ID.

FIG. 10 is a flowchart illustrating the step 906 in FIG. 9 in more detail. Steps 902 to 906 are identical to those in the flowchart in FIG. 9, and thus, description thereof will not be repeated.

First, in step 1002, a transfer request is output to the controller of the main memory which is a transfer destination.

In step 1004, it is determined whether the transfer request has been accepted. The process waits here until the request is accepted.

When the transfer request is accepted, in step 1006, the starting address of the transfer destination which has been set in the address register is sent out.

In the following step 1008, the data is transmitted.

In step 1010, it is determined whether data of the data size that has been set in the data size register has been transferred. If not, the process returns to step 1008.

When the data of the data size set in the data size register has been transferred, in step 1012, the value in the received-ID register is updated with the value of the received ID, and the process returns to step 902.

Hereinafter, the process of control of the DMAC hardware will be described with reference to a flowchart in FIG. 11. While the DMAC hardware control has been described in conjunction with the flowchart in FIG. 9, the process of a more advantageous embodiment will be described below, in which not only the generation ID but also the access timing learning function is used.

Referring to FIG. 11, firstly, a transfer sequence for reading data from the main memory is carried out in step 1102.

In step 1104, it is determined whether the DMA function has been disabled. If not, the process proceeds to step 1106. If the DMA function has been disabled, the DMA operation is terminated.

In step 1106, a transfer sequence for writing data to the main memory is carried out.

After step 1106, the process returns to step 1102.

The step 1102 will now be described in more detail. The ΔT counter 318 included in the interface board 216 takes in the clock from the computer 200 for counting up, and is reset at ΔT time intervals. In step 1110, it is determined whether the value in the ΔT counter 318 is greater than or equal to the value that is obtained by subtracting one (1) from the value in the data-acquisition-timing register. If not, the counting up by the ΔT counter 318 is waited in step 1110. It should be noted that the initial value of the data-acquisition-timing register is preferably set to one or a small value as appropriate.

When the value in the ΔT counter 318 becomes greater than or equal to the value obtained by subtracting 1 from the value in the data-acquisition-timing register, the process proceeds to step 1112. In step 1112, a transfer request is issued to the controller in the main memory which is the transfer source.

In step 1114, it is determined whether the transfer request has been accepted. The process waits in step 1114 until the request is accepted.

When the transfer request is accepted, in step 1116, the starting address of the transfer source which has been set in the address register is sent out.

In the following step 1118, the ID is received from the send buffer 704. This ID is the generation ID of the send data which is shown in FIG. 7. Hereinafter, this ID received is referred to as the “received ID”.

In step 1120, it is determined whether the received ID is new compared to the value in the received-ID register. The received-ID register, provided in the continuous DMA-based data reception control unit 306, is a register for storing the received ID.

If the received ID is not new compared to the value in the received-ID register, the process returns to step 1112.

If it is determined that the received ID is new compared to the value in the received-ID register, in step 1122, the value in the ΔT counter 318 is used to update the value in the data-acquisition-timing register.

Then, in step 1124, the data is received.

In step 1126, it is determined whether data of the data size which has been set in the data size register has been transferred. If not, the process returns to step 1124.

When the data of the data size set in the data size register has been transferred, in step 1128, the value in the received-ID register is updated with the value of the received ID.

While the transfer sequence for writing data to the main memory in step 1106 is not described in detail here, it may be identical to steps 1002 to 1012 in FIG. 10, for example. Alternatively, the learned delay of the access timing may be adopted in step 1106 as well, in which case the sequence may be similar to steps 1110 to 1128 in which the data-acquisition-timing register is used.

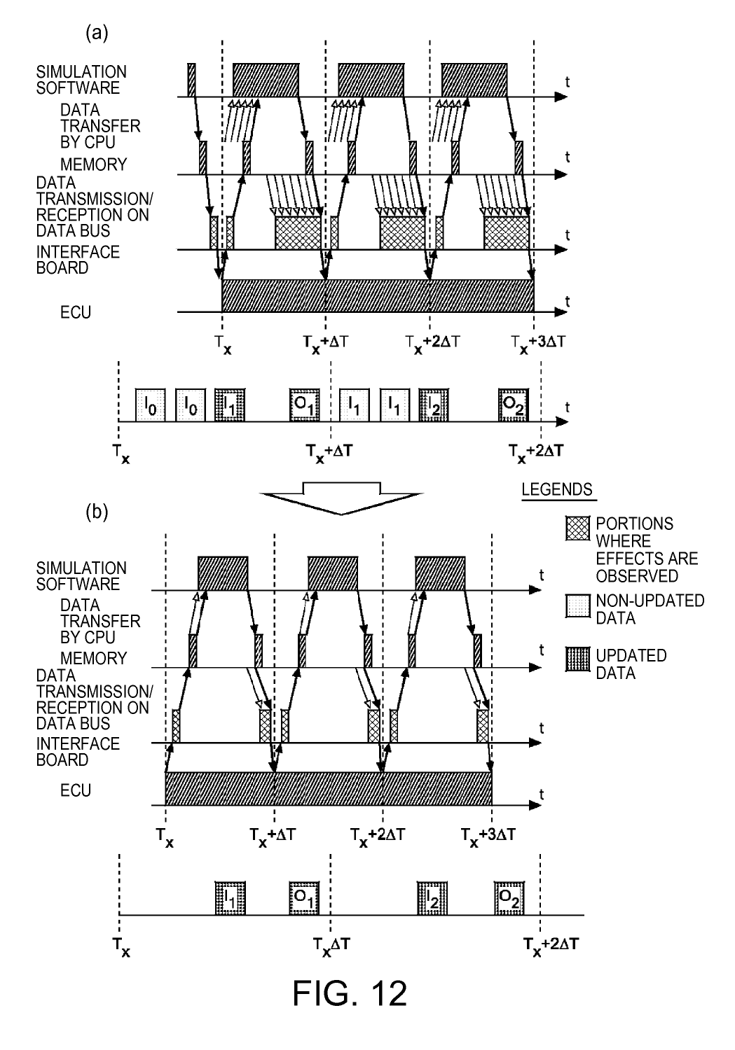

FIG. 12 is a timing chart illustrating the effects obtained by the learned delay of the access timing in FIG. 11. In FIG. 12, I₀, I₁, and the like each represent the data and its ID received at the interface board 216, while O₁ and O₂ each represent the data and its ID transmitted from the interface board 216. I₀ and I₁ represent the received data having the generation IDs of ID₀ and ID₁, respectively. O₁ and O₂ represent the send data having the generation IDs of ID₁ and ID₂, respectively.

FIG. 12(a) shows the timing chart in the case where the access timing learning function is not used, as in FIGS. 9 and 10. In this case, the scheme of the learned delay of the access timing is not used, causing a wasteful attempt indicated by the loop of steps 916, 918, and 910 in FIG. 9. Such unnecessary attempts are shown by the reception of the data with the IDs of I₀ and I₁ that have not been updated.

By comparison, FIG. 12(b) shows the timing chart in the case where the access timing learning function is used, as in FIG. 11. In the process shown in FIG. 11, the ID is received in step 1118 after the delay that has been learned in advance. This increases the possibility that the ID is determined to be the updated ID in step 1120, thereby decreasing the probability that the process returns from step 1120 to step 1112. As a result, the number of wasteful or unnecessary transfer requests can be decreased, whereby the overall data transfer rate can be improved.

While the present invention has been described above in conjunction with the particular embodiment, it should be understood that the present invention is not restricted to the particular embodiment, but applicable to various modifications, replacements, and other configurations and techniques obvious to those skilled in the art. For example, the present invention is not restricted to any particular processor architecture or operating system.

Further, while the above embodiment primarily relates to the HILS for the ECUs in an automobile, it should be understood that the present invention is not restricted thereto, but has wide applications in the HILS for aircraft, robot, and other plant simulations.

Moreover, it would be apparent to those skilled in the art that the present invention can be used for any applications, besides the simulations, where small-sized data pieces need to be transferred frequently.

### DESCRIPTION OF SYMBOLS

200 computer
202 system bus
204 CPU
210 keyboard
212 mouse
214 display
206 main storage
202 bus
216 interface board
218 ECU
208 hard disk drive
302 simulation software
304 receive data buffer
306 data reception control unit
308 access timing learning unit
310 input circuit interface unit
312 output circuit interface unit
314 send data buffer
316 data transmit control unit
318 ΔT counter
404 interface logic
406 serial cable
408 flat cable
702 receive buffer
704 send buffer
706 previously-received-generation-ID storing area

We claim:

1. A computer system having a data transfer device for transferring data from a memory in a computer to a peripheral device via Direct Memory Access (DMA), the computer system comprising:
a continuous DMA mechanism configured to successively and repeatedly output a data transfer request in response to an enable process;
means for placing, in the memory, data to be transferred to the continuous DMA mechanism and generation ID data, the generation ID data being updated whenever the data is placed in the memory;
means for transferring the data together with the generation ID data from the memory to the continuous DMA mechanism in response to a data read and transfer request from the continuous DMA mechanism; and
means for disabling the continuous DMA mechanism,
wherein the continuous DMA mechanism comprises: means for storing the transferred generation ID as a received ID; and means for receiving the transferred data in response to the event that the transferred generation ID differs from the received ID being stored.

2. The computer system according to claim 1, wherein the continuous DMA mechanism comprises:
a time controlling mechanism for taking in a clock from the computer system for counting up and for resetting the clock at an interval of a predetermined time; and
means for operating on a cycle of the predetermined time; and
wherein the computer system further comprises:
timing storing means for storing a period from a start time of the cycle of the predetermined time to a time when the updated data is transferred; and
means for outputting the data transfer request only during the period stored in the timing storing means from the start time of the cycle of the predetermined time, so as to delay the transfer operation by the data transferring means.

3. The computer system according to claim 1, further comprising:
means for transferring data from the continuous DMA mechanism to a peripheral device connected to the computer.

4. The computer system according to claim 3, wherein the peripheral device is an Electronic Control Unit (ECU), and the data to be transferred from the memory to the continuous DMA mechanism is generated by simulation software.

5. The computer system according to claim 4, further comprising:
a send buffer for storing data transmitted from the ECU;
means for storing a sending generation ID;
means for transferring a content in the send buffer together with the sending generation ID to the memory in response to the event that a write data transfer request to the memory is accepted from the continuous DMA mechanism; and
means for updating the value of the sending generation ID in response to completion of the transfer to the memory.

6. A data transfer method in a computer system having a data transfer device for transferring data from a memory in a computer to a peripheral device, the data transfer method comprising the steps of:
successively and repeatedly outputting a data transfer request by a continuous DMA mechanism in response to an enable process;
placing, in the memory, data to be transferred to the continuous DMA mechanism and generation ID data, the generation ID data being updated whenever the data is placed in the memory;
transferring the data together with the generation ID data from the memory to the continuous DMA mechanism in response to a data read and transfer request from the continuous DMA mechanism;
storing, by the continuous DMA mechanism, the transferred generation ID as a received ID;
receiving the transferred data in response to the event that the transferred generation ID differs from the received ID being stored; and
disabling the continuous DMA mechanism.

7. The data transfer method in the computer system according to claim 6, further comprising the steps of:
storing a period from a start time of the cycle of the predetermined time to a time when the updated data is transferred; and
outputting the data transfer request only during the period stored in the timing storing step from the start time of the cycle of the predetermined time, so as to delay the transfer operation in the data transferring step;
wherein the continuous DMA mechanism comprises:
a time controlling mechanism for taking in a clock from the computer system for counting up and for resetting the clock at an interval of a predetermined time; and
means for operating on a cycle of the predetermined time.

8. The data transfer method in the computer system according to claim 6, further comprising the step of transferring data from the continuous DMA mechanism to a peripheral device connected to the computer.

9. The data transfer method in the computer system according to claim 8, wherein the peripheral device is an Electronic Control Unit (ECU), and the data to be transferred from the memory to the continuous DMA mechanism is generated by simulation software.

10. The data transfer method in the computer system according to claim 9, further comprising the steps of:
storing data transmitted from the ECU;
storing a sending generation ID;
transferring the data stored in the data storing step together with the sending generation ID to the memory in response to the event that a write data transfer request to the memory is accepted from the continuous DMA mechanism; and
updating the value of the sending generation ID in response to completion of the transfer to the memory.

11. The data transfer method in the computer system according to claim 10, further comprising the steps of:
storing, by the simulation software, the value of the sending generation ID transferred from the continuous DMA mechanism; and
comparing, by the simulation software, the generation ID being stored with the value of the sending generation ID transferred from the continuous DMA mechanism, so as to confirm that the data transferred from the continuous DMA mechanism is latest data.
